(19) United States
(12) Patent Application Publication
(10) Pub. No.: US 2026/0065795 A1
(43) Pub. Date: Mar. 5, 2026

(54) SYSTEMS, METHODS, AND INTERFACES FOR FACILITATING DEVELOPMENT OF READING COMPREHENSION

(71) Applicant: Phillip John Chipping, American Fork, UT (US)

(72) Inventor: Phillip John Chipping, American Fork, UT (US)

(21) Appl. No.: 19/009,548

(22) Filed: Jan. 3, 2025

Related U.S. Application Data
(60) Provisional application No. 63/688,504, filed on Aug. 29, 2024.

(51) Int. Cl. G09B 5/02; G06F 40/109; G09B 5/04

(52) U.S. Cl. CPC G09B 5/02; G06F 40/109; G09B 5/04

(57) ABSTRACT

To facilitate learning to read, an input text can be modified to a modified text and presented to a reader. The input text can include a plurality of worlds. The input text can be run through a filter. A visually distinguishing feature can be applied to words in the input text based on the filter to create the modified text. The modified text, including the words with the visually distinguishing features and the words without the visually distinguishing features, can be presented to the reader.

### BACKGROUND

### Technical Field

Embodiments of the invention relate to learning to read. More particularly, at least some embodiments relate to systems, hardware, software, computer-readable media, and methods for learning to read and/or reading development.

### Background

Reading is a fundamental skill that is taught from a young age. However, not everyone learns to read at the same rate or in the same manner. Learning to read often requires the reader to learn rules about how words are spelled and pronounced for example. Some individuals may struggle to learn certain rules while others may not struggle with those same rules.

Learning to read, however, is not solely the responsibility of the learner. Some of the responsibility may also fall on the teacher. In a classroom setting, for example, teaching a group of individuals to read can be a complex process that requires the teacher to somehow account for the unique learning abilities and capabilities of multiple individuals. This is a challenging and complex task. Thus, many teachers and learners may benefit from different teaching/learning methods.

The abilities of various individuals also vary. Some learners grasp rules quickly while others may be a little slower. In addition, some learners may be burdened with other challenges such as dyslexia. For example, dyslexic individuals often encounter significant challenges when learning to read due to the unique ways their brains process language. Unlike their non-dyslexic peers, individuals with dyslexia often struggle with phonemic awareness, which is the ability to recognize and manipulate the individual sounds in words. This difficulty hampers their ability to decode words, leading to problems with reading fluency and comprehension. Accordingly, there are a number of difficulties in the field of learning to read.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, implementations described herein will be described and explained with additional specificity and detail through the use of the accompanying drawings in which:

FIG. 1A discloses aspects of a learning system configured to facilitate learning to read;

FIG. 1B discloses aspects of a method in accordance with one or more implementations of the present disclosure;

FIG. 2 discloses aspects of a computer system or environment in accordance with one or more implementations of the present disclosure;

FIG. 3 discloses aspects of another computer system in accordance with one or more implementations of the present disclosure;

FIG. 4 discloses aspects of another computer system in accordance with one or more implementations of the present disclosure;

FIG. 5 discloses aspects of a flowchart of a method in accordance with one or more implementations of the present disclosure.

### DETAILED DESCRIPTION

One of the challenges in learning to read (e.g., for a struggling reader and/or a dyslexic reader) is practicing words they have learned, while also reading material of interest to the reader. There are two main rules to learning to read known throughout the field of what may be referred to as the Science of Reading. They are: first, presenting reading material on the child's reading/skill level, and second, presenting reading material the child is interested in. Without both of these, learning to read is an uphill battle, even for children without learning difficulties/differences.

Current solutions on the market, especially for struggling and/or dyslexic children, focus almost solely on the skill side—by providing lists of example words to learn at each level (normally not comprehensive lists of every single word based on the rule of that lesson), as well as what are known as “decodable” texts (which are texts and books made up solely of words the child has learned to that point—this is their attempt to give kids more interesting content but it fails). These lists of vocabulary words and these decodable texts are boring. Children are not interested in them. They also tend to be far under a child's intellectual capacity/interest level (often children are not discovered to have reading challenges, and no intervention takes place, until 4th-6th grade), leading these children to feel like they're stupid, feel demoralized, and learn to hate reading.

Embodiments of the invention addresses these issues and problems. Embodiments of the invention combine both the skill side (clearly showing the children which words they know and which words they need to practice) and the interest side (by presenting them with real stories, actual ebooks, real articles about fascinating subjects, real news articles, etc.)—content that they can be excited about, interested in, and content that is on their own intellectual level.

By presenting children with content they want to read, and by giving them and their parents/tutors/teachers a clearly defined way to know and practice the words they have learned or are learning on the lesson they are on, an environment and system is created that, for the first time, opens up the world of text/words and reading in a way that is enjoyable and doable. That combination naturally drives learning at a faster, easier pace.

Implementations described herein provide systems, methods, and computer program products to facilitate learning to read. Embodiments of the invention are discussed in the context of learning to read. Learning to read may include, by way of example and not limitation, reading decoding, reading comprehension, reading development, learning methodologies, teaching methodologies, and the like or combinations thereof.

Embodiments of the invention relate to, by way of example, phonics based reading curriculum. Embodiments of the invention can be used by readers regardless of reading level, reading skill, grade level, reading challenge and/or reading difficulty. Embodiments of the invention are further configured to adapt to an individual's reading level, challenge, or difficulty. Embodiments of the invention are further discussed in the context of English, but are applicable to any other language.

Generally, embodiments of the invention relate to a reading engine that includes a filter. The filter can be configured according to one or more of curriculum, level, user characteristics (curriculum level, age, skill, level). The filter is able to transform reading material to a form configured to facilitate the process of learning to read.

More specifically, the filter is configured to receive reading material as input. The input is typically in a form of text or is converted to text in one example. If necessary, reading material may be prepared for input to the filter. A book, for example, may be scanned and converted to text or other suitable format. The output may be presented as text, image, or the like.

The filter also receives other inputs that may include, by way of example, one or more of reading level, age, challenge (e.g., diagnosis), grade level, curriculum level, or the like or combinations thereof.

The reading engine is configured to adapt the input to a specific user. Thus, for a given input, the output for a first user may differ from the output for a second user. The reading engine is configured to generate an output (e.g., reading material) that is configured specifically for the user. This allows, in one example, each member of a class, to read the same reading material in a manner that benefits each individual in a customized or tailored manner.

In one embodiment, the filter identifies words in the input reading material that the user has learned or is currently learning based on the user inputs to the filter. More specifically, the other user inputs (e.g., one or more of reading level, curriculum information, or the like or combinations thereof) are used to identify words in the input text that the user knows or is learning (the known words). The filter thus identifies or determines known words in the input text and unknown words in the input text. Once the input is processed by the filter, an output (e.g., output text) is generated by the reading engine.

In some examples, the reading engine changes the visual appearance of the output. In one example, the visual appearance of the known words (or portions thereof) identified by the filter is changed. The known words may be bolded, italicized, highlighted, or otherwise emphasized. The font and/or point size of the known words may also be changed for visual emphasis. In one example, the unknown words may/may not be presented in a different manner. For example, the unknown words may be made smaller such that the known words are visually emphasized. In another example, known words from previously completed lessons may be given a first visual appearance while words being learned may be given a second visual appearance. Unknown words may be given a third visual appearance or presented without change. For instance, known words may be bolded and black. Words associated with a current lesson may be bolded, larger, and red. There are multiple variations of visual appearances.

In one example, the reading engine may be configured to generate output in different manners. For example, the output may include an audio portion, an image portion, and/or a video portion. The output may be presented as a digital book and include original images. The output could be directed to a printer.

The audio portion may include, by way of example, the unknown portion. This allows, in one example, a user to audibly play the unknown portion and follow along. The audio may pause when a known word is reached and can be restarted automatically or manually after the known word is read. The reading engine may include a speech recognition component able to determine whether the known words are pronounced correctly by the learner. Embodiments of the invention provide flexibility in the output.

In addition, embodiments of the invention relate to output that is published or printed. For instance, a book may be published in different forms where each form or version corresponds to a particular reading level or curriculum level. A book for a first reading level may include different known words compared to the same book from the perspective of a second reading level.

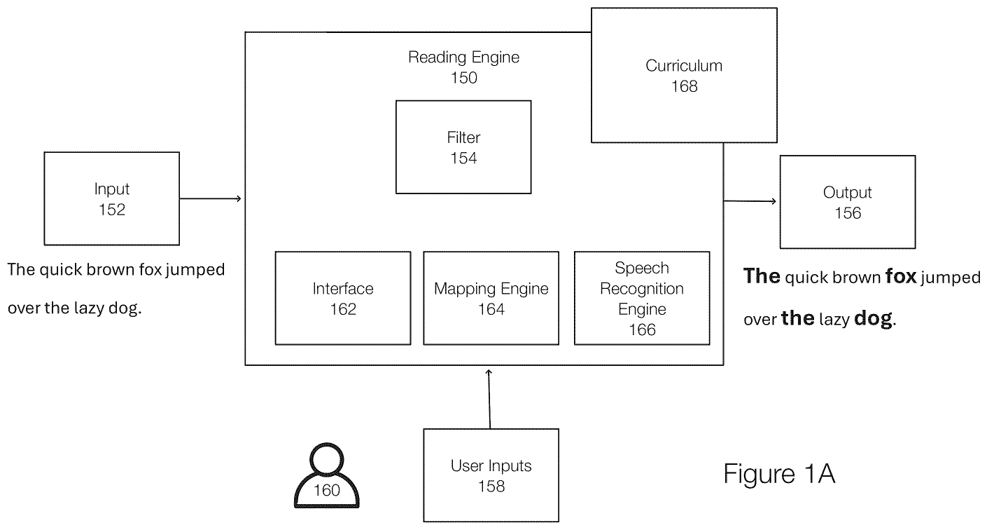

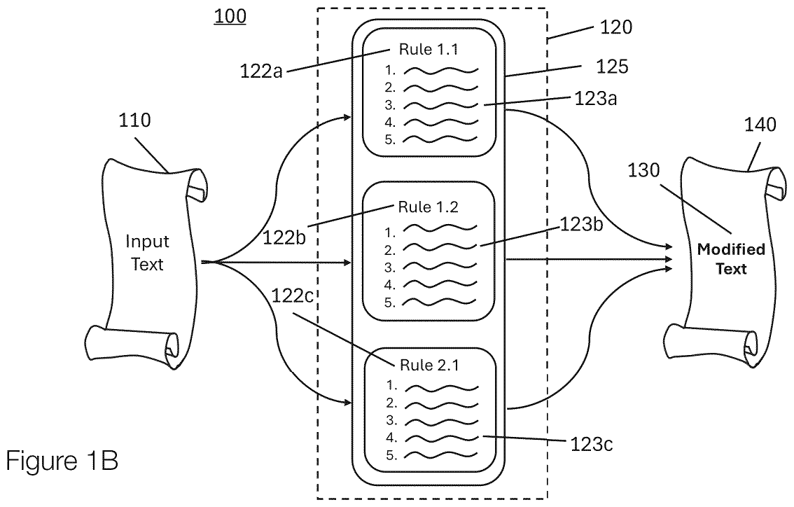

FIG. 1A discloses aspects of a reading engine configured to facilitate learning to ready. FIG. 1A illustrates a reading engine 150 that includes a filter 154. The reading engine 150 may include processors, memory, networking hardware or the like. The reading engine 150 may be an application operating in a computing system. The reading engine 150 may operate on a computer, a laptop computer, a tablet, a smartphone or other computing device. The reading engine 150 may operate in a distributed manner with a device portion and a cloud portion (e.g., a client/server configuration).

The input 152 is representative of text or other reading material. The input 152 may be stored on a computing device or memory that is local or remote with respect to the reading engine 150. The input 152 may include a digital book, a text file, a word processing document, or any other format or file. The format of the input 152 may be altered if necessary (e.g., a pdf or image may be converted to text).

The reading engine 150 may also receive user inputs 158. The user inputs 158 may include aspects regarding or characteristics associated with a user 160. For example, the user 160 may be learning to read using a curriculum that includes classes and lessons. Class 1 may include lessons 1-6. Class 2 may include lessons 1-6. The format or structure of the curriculum may vary. Via a user interface 162, the user 160 may input class 2, lesson 6 of curriculum X into the reading engine 150. The mapping engine 164 may, if necessary, map the user inputs to a reading level or other representation. For example, if the reading engine 150 is based on a curriculum Y, the curriculum X is mapped to the curriculum Y (e.g., class 2 lesson 6 of curriculum X may map to class 1 lesson 12 of curriculum Y). This allows the reading engine to generate appropriate output for any user regardless of the curriculum used by the user.

The reading level of the user 160 may be used by the filter 154 to process the input 512 to determine or identify the known words (words learned and/or currently being learned by the user 160) included in the input 152. Once the known words are identified, an output 156 is generated.

The filter 154 may include a database of words that are related to a reading level. Once the reading level of the user 160 is determined, the database may be accessed to identify known words for that reading level. The input 152 is then compared to the known words associated with the reading level to identify which of the known words already exist in the input 152. The known words can then be changed or transformed and presented in the output 156.

In one example, the database may be constructed using rules. For instance, a particular reading level may be associated with a specific list of rules or just one rule. All words that relate to those rules or that one rule can be associated with that reading level.

In another example, the filter 154 may evaluate the words in the input 152 from a rule perspective. In this example, the rules associated with each word in the input 152 are identified. This can be compared to a list of rules associated with a particular reading level. Complete matches are visually distinguished. Words associated with rules not included in or associated with the reading level are deemed unknown words. Thus, the known and unknown words can be identified in different manners.

FIG. 1A illustrates an example of how input text is transformed and output by a reading engine 150. In this example, the input 152 is represented by the following text:

The quick brown fox jumped over the lazy dog.

The user inputs 158 are received by the filter 154. The filter 154 may then determine words that are known to the user 160. The input 152 is processed to identify or determine the known words with respect to the user 160 that are present in the input 152. The output 156 is generated such that the known words are presented with a different visual appearance. In one example, the known words are visually distinguished from the unknown words. In this example, the known words are bolded and made larger as follows:
The Quick Brown Fox Jumped Over the Lazy Dog.

If the user inputs 158 were for a more advanced class/lesson (or reading level), the output 156 may be presented as:
The Quick Brown Fox Jumped Over the Lazy Dog.

This demonstrates that the reading engine 150 is able to account for the capabilities and abilities of each individual user.

The output 156 may be presented on one display, multiple displays, or the like. This may allow, for example, a teacher to read with a learner (even when in different geographic locations). In some examples, the known words may have different visual characteristics. For instance, known words from a previous level may have a different visual representation from words currently being learned. In this example, the output 156 may be represented as follows:
The quick brown fox jumped over the lazy dog.

This example illustrates that previously known words are bolded and larger while known words being learned are also underlined. The manner in which known words are visually distinguished may vary and may include, but is not limited to, highlighting, italicizing, font changes, or the like or combinations thereof.

The reading engine 150 may also include a speech recognition engine 166. The engine 166 may allow the reading engine 150 to determine whether the user 160 is actually learning or pronouncing the known words (and/or the unknown words) correctly. This may give the reading engine 150 insight regarding rules that may not be fully learned or understood and allow the curriculum to be adjusted. For example, the reading engine 150 may suggest that the user repeat a prior lesson. The engine 166 may measure reading speed, pronunciation, or determine other characteristics of the user's progress/learning. The engine 166 may be able to detect whether a user has difficulty with specific words and may be able to identify rules the user may not understand such that the lesson can be adapted to focus on rules that have not been learned.

In one example, the reading engine 150 may be associated with a curriculum 168 or reading levels that are based on a particular curriculum. The mapping engine 164 may be configured to map relevant user inputs to the curriculum 168. Alternatively, the reading engine 150 may have a database of various curriculums that can be used by the reading engine 150 to configure the inputs to the filter 154.

The curriculum 168 may also include lessons for words that may not be rule based such as corporate brand names, words with different spellings, and the like.

In another example, the input 152 may be a web page or other online content. The filter 154 may be a browser plugin. The output 156 may be a webpage that is adapted to the reading level or capability of the user. Thus, known words may be visually distinguished in the web page or other online based content without losing the functionality of the webpage in one example. Thus, links still function. To the extent that words are presented in graphic form, text recognition may be able to extract text from images such that the words in the images can be distinguished. For example, if text in an image can't be bolded or enlarged, the color of the image surrounding the text may be changed to highlight the words.

As discussed above, the input 152 may vary widely and have a wide variety of different sources that may include, but are not limited to, digital content, web pages, documents of various formats (e.g., docx, pdf), physical books, images of text/pictures (e.g., .jpg) or the like. Embodiments of the invention contemplate various input devices such as a camera or cameras. This allows the reading engine 150 to capture an image of a page of a book and generate an output 156 as discussed herein.

Embodiments of the present invention relate to systems, methods, and computer program products facilitate development of learning to read. In at least one implementation, the method enables a quick and efficient generation of a modified text for learning to read. As such, implementations of the present disclosure improve learning by providing modified text for the reader.

Along these lines, an example method may include receiving input text (or other input) including a plurality of words, running the input text through or processing the input text with a filter to identify known words, applying a visually distinguishing feature to the known words to generate an output or modified text, and presenting the modified text including the words with the visually distinguishing features and the words without the visually distinguishing features to a reader.

In an additional or alternative implementation, a computer system that facilitates learning to read can include one or more processors and one or more computer-readable hardware storage devices that store instructions that are executable by the one or more processors to perform the methods disclosed herein.

Additional features and advantages will be set forth in the description which follows, and in part will be obvious from the description, or may be learned by practice. The features and advantages may be realized and obtained by means of the instruments and combinations particularly pointed out in the appended claims and aspects. These and other features will become more fully apparent from the following description and appended claims or may be learned by the practice of the examples as set forth hereinafter.

According to one implementation, a method for facilitating learning to read may include receiving input text that may include a plurality of words. The method may be computer-implemented or may be performed by an individual. The input text may be any form of text, including digital or physical. For example, the input text may be a book, newspaper, article, magazine, journal, brochure, or any physical medium that carries text. The input text may also be an eBook, webpage, PDF file, Microsoft Word® Document, email message, blog post, social media post, text message, online forum, or any other digital medium that carries text. In another example, if the text is represented in another format (e.g., an image), the input may be converted to text.

Each kind of input text may offer unique advantages applicable to everyday life. As a reader continues to learn how to read, a broader range of source materials may become available for the reader to read. The diverse styles, vocabularies, and contexts provided by different kinds of text may enrich the reading experience and can cater to various learning preferences and needs.

For example, the reader may exhibit a preference for a particular source material such as webpages, and implementations of the present disclosure may assist the reader in learning words on the web pages, increasing literacy, quality of life, and reading comprehension. Because the input text may vary widely, readers are provided with greater access to the resources and materials that they want to read.

The method may also include running the input text through (or applying) a filter. The filter may be computer implemented or may be implemented manually by an individual. The filter may include a list of words that represents the words that the reader should know. The filter may be configured prior to filtering based on user inputs, such as reading level, curriculum, or the like.

For example, a list of words may be based on one or more rules. Each rule may be associated with a corresponding sub-list of words, and words within each sub-list may be associated with one or more rules. Some words may not be associated with a rule. Such words may require even further repetition and practice for individuals to learn. Thus, a certain class/lesson may be associated with a list of known rules. The filter may identify all words that comply with all of the rules that have been learned.

The reader may have a reading level that indicates how many and which rules the reader has learned and/or is currently learning. The more rules the reader learns, the more words the reader may know how to read. Similarly, the less rules the reader has learned, the less words the reader may know how to read. The reader may memorize words that are not associated with a rule separately from the words associated with a rule.

According to some implementations, the method includes determining a reading level of the reader. Determining the reading level may include identifying one or more rules that the reader has learned or identifying the current progress of a reader in a curriculum. Because each rule may be associated with a corresponding sub-list of words, the number of rules that the reader has learned, and which rules the reader has learned, may indicate the reading level of the reader and what words the reader knows how to read. Additionally, based on the reading level of the reader, a list of known words may be created. In some implementations, the reader may simply provide the reading level, or the reading level may be automatically determined based on how many and/or which rules the reader has learned.

In some implementations, the filter is created based off of the list of known words that is created based on the reading level of the reader. Because the filter is created for or configured for each individual reader, the method provides an individualized and inclusive approach to readers of all abilities. Readers that learn with a lower speed or have specific challenges (e.g., dyslexia) benefit because the filter can help the reader focus on either those words that the reader has learned how to read or those words that the reader is still trying to learn how to read.

Additionally, the method may include applying a visually distinguishing feature to words in the input text based on the filter to create a modified text. The visually distinguishing feature may include a bold typeface, an underlined typeface, a highlight, different colored typeface, an italicized typeface, a larger or smaller sized font, or any other visually distinguishing feature, or combinations thereof. The visually distinguishing feature may be applied to words in the input text based on the list of words associated with the filter. Because the list of words in the filter may include words that are associated with rules that the reader may know and/or is learning, the reader may know each word visually distinguished in the output text.

Accordingly, the visually distinguishing feature may be applied to words that the reader may know using the filter, and may not be applied to words that the reader does not know. Alternatively, the visually distinguishing feature may be applied to words that the reader does not know using the filter. In any event, a modified text may thus be created by running or processing the input text through the filter and applying a visually distinguishing feature to certain words in the input text. The modified text may have words that have the visually distinguishing feature and words that do not have the visually distinguishing feature.

Visually distinguishing certain words allows both the reader and a tutor, teacher, or coach to see which words the reader does and does not know quickly and clearly. This may further advance the reader's learning by providing personalized and clear display of the words that the reader knows and does not know. It may also enable the reader to receive an increased level of instruction, as instructors are intuitively and clearly appraised to words that the reader knows and does not know.

FIG. 1B illustrates a diagram of a method in accordance with one implementation of the present disclosure. As shown in FIG. 1B, a method 100 for facilitating learning to read may include receiving input text 110 that may include a plurality of words.

Because the input text 110 may be from virtually any source, greater individuality may be achieved in the learning and improving process. For example, a reader may express preferences for a particular source of text such as a book or a webpage. The reader may thus have greater motivation to learn how to read and improve reading comprehension as the reader reads text from the reader's preferred source. Accordingly, the method 100 may enable a customizable, personal, and individually tailored approach to increasing reading comprehension and literacy of the reader.

FIG. 1B also shows that the method 100 may include running the input text 110 through or processing the input text 110 with a filter 120. The filter 120 may be computer implemented, or may be manually implemented by an individual. According to some implementations, the filter 120 may include a list of words 125. The list of words 125 (an example of a database used by or included in the filter 120, which is an example of the filter 14) may include or be associated with one or more rules 122a, 122b, 122c and each rule may be associated with a corresponding sub-list of words 123a, 123b, 123c. While a particular number of rules and corresponding sub-lists of words is shown in FIG. 1B, the present disclosure is not limited to any particular number of rules and sub-lists of words. Further the list of words 125 may have a different form or different relationships. Further, the filter may identify known words on-the-fly.

The number of rules and corresponding sub-lists of words that are included in the list of words 125 may depend on a reading level of the reader. The reading level of the reader may be determined by identifying one or more rules that the reader has learned. In the example shown in FIG. 1, the reader has learned three rules 122a, 122b, 122c that each have a sub-list of words 123a, 123b, 123c. The sub-lists of words 123a, 123b, 123c may be combined to form the list of words 125 that is included in the filter 120. In some examples, specific sub-lists may be generated from a larger database based on rules that the reader has learned, which may be determined based on reading level, curriculum selection, or the like.

The list of words 125 may beneficially change from reader to reader. Additionally, the list of words 125 may change as the reader's reading comprehension level changes. Because the list of words 125 may be formed by combining one or more sub-lists of words 123a, 123b, 123c that correspond to one or more rules 122a, 122b, 122c, the method 100 may beneficially allow for an adjustable and configurable experience while improving reading comprehension of multiple different readers.

As an illustrative example, a reader may have a reading level that includes six rules. Each of the six rules may include a corresponding sub-list of words that includes one hundred words. Because the reader has learned six rules, the reader should thus be able to read the six hundred words associated with the sub-lists that correspond to the words. As the reader continues to learn and improve reading comprehension, the reader may learn an additional three rules, each of which having (for example) a corresponding sub-list of words that includes eighty words. The reader should now be able to read a total of eight hundred and forty words. Some words in the corresponding sub-list of words may be governed by multiple rules and as such may appear in multiple sub-lists. Additionally, the reader may learn words that are not associated with any rules. Such words may also be used to create the filter 120.

The method 100 may thus include running the input text 110 through a filter 120. As additionally described above, the method 100 may include determining a reading level of the reader, creating a list of words 125 that may be known words based on the reading level of the reader, and using the list of words 125 to create the filter 120.

FIG. 1B additionally shows that the method 100 may include applying a visually distinguishing feature 130 to words in the input text based on the filter to create a modified text 140.

According to some implementations, the visually distinguishing feature 130 may be applied to words in the input text 110 that correspond to words in the list of words 125 (that may be a list of known words as described above) associated with or identified by the filter 120. Alternatively, the visually distinguishing feature 130 may be applied to words in the input text 110 that correspond to words that are not in the list of words 125 (that may be a list of unknown words as described above) associated with the filter 120. Accordingly, some words in the input text 110 may be applied with a visually distinguishing feature 130, and some words in the input text 110 may not be applied with a visually distinguishing feature 130. In a case where the reader knows rules that govern each and every word in the input text 110, the visually distinguishing feature 130 may be applied to each and every word in the input text 110 in order to create a modified text 140. Similarly, in a case where the reader does not know any words in the input text 110, the visually distinguishing feature 130 may not be applied to any word in the input text 110.

The rare cases described above (e.g., where the reader knows all or none of the words in the input text 110) may serve to illustrate at least one purpose of the visually distinguishing feature 130; because of the visually distinguishing feature 130, a reader and/or mentor, tutor, teacher, or coach may quickly be apprised of which words the reader knows and which words the reader does not know. This may beneficially enable the reader to discern the appropriateness of any input text 110 readily and clearly in relation to the reader's reading level.

For example, if the reader does not know many rules, then less words will receive the visually distinguishing feature 130 than if the reader knows more rules. Accordingly, the visually distinguishing feature 130 may enable an efficient improvement of reading comprehension through rapid analysis of an input text 110.

The visually distinguishing feature 130 may also enable a coach, mentor, tutor, teacher, or other similarly positioned individual (referred to herein as an “instructor”) to assist the reader in improving reading comprehension by distinguishing the words that the reader knows from the words that the reader does not know. For example, the reader may focus on the words that are applied with the visually distinguishable words, and the instructor may assist the reader in reading the words that the reader does not know.

As discussed above, because the input text 110 may be virtually anything or from virtually any source, the reader may be enabled to read text from sources in which the reader is interested. Moreover, because the words that the reader already knows are applied with a visually distinguishable feature 130, the reader is further enabled to read from such sources by focusing on the words that the reader already knows.

The visually distinguishing feature 130 may also be distinct for each rule that the reader has learned. For example, the visually distinguishing feature 130 may have a particular color that corresponds to a particular rule, and the particular color may be different for each rule. In such a way, readers are enabled to quickly identify each word that the reader knows along with the corresponding rule that the reader knows.

FIG. 1B also shows that the method 100 may include presenting the modified text 140 including the words with the visually distinguishing feature 130 and the words without the visually distinguishing feature 130 to a reader. Presenting the modified text 140 to the reader may include presenting the modified text 140 on a graphical user interface display of a computer system, in the event that the method 100 is implemented by a computer. Similarly, the modified text 140 may be printed on paper via a printer associated with or part of the computer. However, the present disclosure is not limited to computer implementations of the method. One skilled in the art will appreciate that the above discussed method 100 may be implemented manually by an individual. In such an implementation, presenting the modified text 140 may include creating and presenting either a physical or digital version of the modified text 140 to the user.

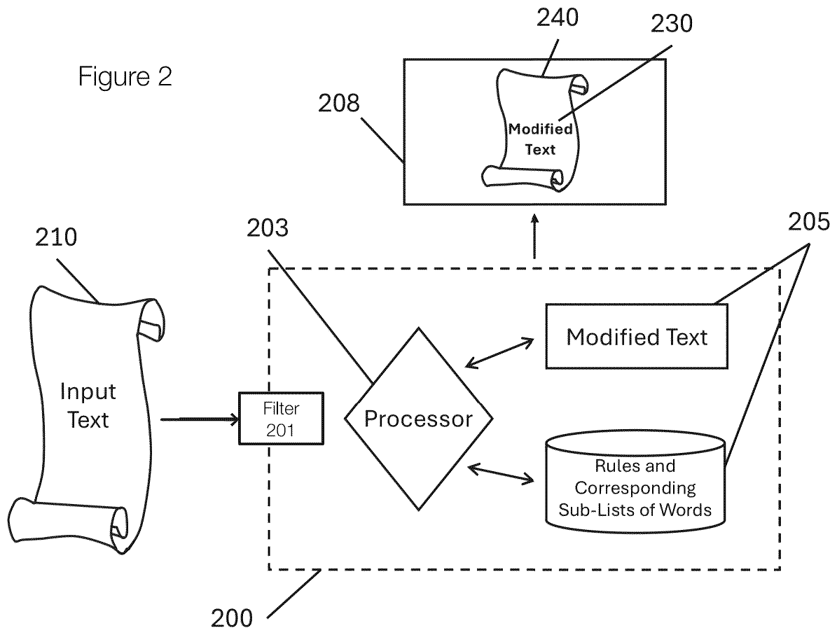

FIG. 2 illustrates a computer system in accordance with one implementation of the present disclosure. According to FIG. 2, a computer system 200 may have one or more processors 203 and one or more computer-readable hardware storage devices 205 that store instructions that may be executable by the one or more processors 203 to cause the computer system 200 to receive input text 210 that may include a plurality of words; run the input text 210 through a filter; apply a visually distinguishing feature 230 to words in the input text based on the filter to create a modified text 240; and present, on a graphical user interface 208, the modified text 240 including the words with the visually distinguishing feature 230 and the words without the visually distinguishing feature 230 to a reader.

Accordingly, FIG. 2 shows that the computer system 200 may implement aspects of the above-described method, and thus the computer system 200 may enable each of the features, implementations, and advantages described above in association with the method 100 for facilitating development of reading comprehension.

FIG. 2 also shows that the computer system 200 may include instructions that may additionally cause the computer system 200 to determine a reading level of a reader. The computer system 200 may include a filter 201, which is an example of the filter 154. In some implementations, the computer system 200 may also be a representation of a reading engine and may have one or more storage devices 205 for storing information regarding rules and sub-lists of words. The computer system 200 may also store information as to the reading level of one or more readers based on one or more prior reading sessions.

As an example, if a reader with a reading level indicating that the reader has learned six rules finishes a reading session with a reading level that indicates that the reader has now learned seven rules, then the computer system 200 may store the higher reading level for that reader. When the reader begins a new session, the computer system 200 may automatically determine that the reading level of that reader indicates that the reader has learned seven rules and may proceed accordingly. Accordingly, determining a reading level of a reader may include automatically determining the reading level of the reader based on one or more prior reading sessions with the reader. Such an implementation is not limited to the computer system 200, as one skilled in the art will appreciate that such may also be done manually by an individual.

In an additional or alternative implementation, the computer system 200 may receive manual input that indicates the reading level of the reader. In such an implementation, the reader may input the reader's reading level into the computer system 200. The computer system 200 may use the reading level to determine one or more rules that the reader has learned. Based on the one or more rules that the reader has learned, the computer system 200 may determine a filter 201 that includes a list of words that may be a list of known words. The list of words may include one or more corresponding sub-lists of words that correspond to one or more rules that the reader has learned.

The computer system 200 may then run the input text 210 through the filter 201 and apply a visually distinguishing feature 230 to words in the input text based on the filter 201 to create a modified text 240. The computer system 200 may then present, on the graphical user interface 208, the modified text 240 including the words with the visually distinguishing feature 230 and the words without the visually distinguishing feature 230 to the reader.

In an additional or alternative embodiment, the computer system 200 may highlight, on the graphical user interface 208, each word in the modified text in succession as the reader reads the modified text at a fixed or variable speed. Words with a visually distinguishable feature 230 may be highlighted in addition to the visually distinguishable feature 230 as the reader reads the respective words. For example, the modified text 240 may be presented on the graphical user interface 208 to a reader, and the reader may begin reading. As the reader is reading, the computer system 200 may highlight each word that the reader is reading one after the other, including words that are applied with a visually distinguishing feature 230.

The computer system 200 may continue highlighting each word until the reader gets to a word that does not have a visually distinguishing feature 230 applied to the word. The computer system 200 may skip over such a word and continue highlighting subsequent words. Such an implementation may beneficially assist a reader to focus on words that the reader knows and/or has learned. This may be especially beneficial for readers with dyslexia by enabling them to focus only on words that they know the associated rules for. Because readers are able to focus only on words that they know, the readers are able to learn rules more quickly and thus have an improved reading comprehension.

In some examples, the computer system 200 may be configured to listen to the reader. This may allow the computer system 200 to determine whether the reader has learned the lesson (e.g., when the computer system determines that the reader correctly says the words being learned), determine whether lessons should be repeated or adapted, or the like. In some examples, the computer system 200 may read the unknown words, stop or pause at appropriate times to allow the reader to say the known words or words being learned. This may allow the reader's pronunciation to be evaluated. In addition, the time required for the reader to say the known work may indicate how well the lesson was learned and may be used to focus the curriculum. The computer system 200 may include a voice to text converter, use large language models, and the like. Large language models may allow the computer system 200 to interact with the reader in a natural language manner and respond to the reader's questions using the curriculum as source documents for generating an answer.

In some examples, detecting that the reader is having trouble with a word (e.g., based on time, pronunciation, or the like), the computing system may present a mini lesson to remind the reader of the relevant rule, provide an audible cue (e.g., saying the word) and then prompt the user to try again.

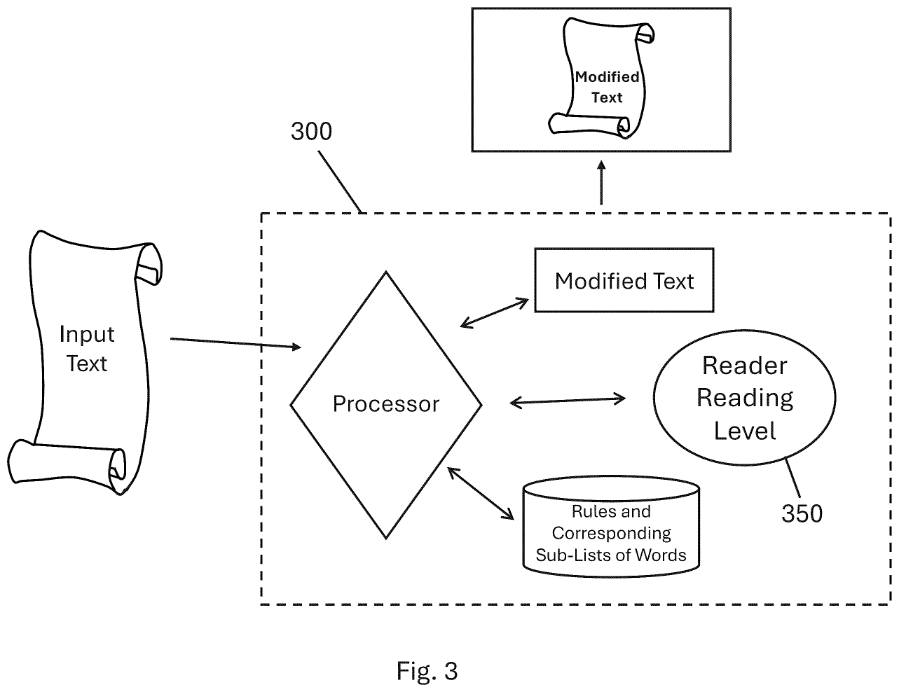

FIG. 3 illustrates another computer system in accordance with one or more implementations of the present disclosure. As shown in FIG. 3, the computer system 300 may store a reader reading level 350. Accordingly, the computer system 300 may automatically determine the reading level for a reader by retrieving the stored reading level 350 for the reader. As discussed above, the reading level may be indicative of and may be used to identify which and how many rules the reader has learned. Each rule may have a corresponding list of words. In some implementations, the computer system 300 may automatically keep track of how many and which rules and words the reader knows based on the stored reading level 350. Such an implementation may beneficially simplify the learning process by reducing the workload of the reader.

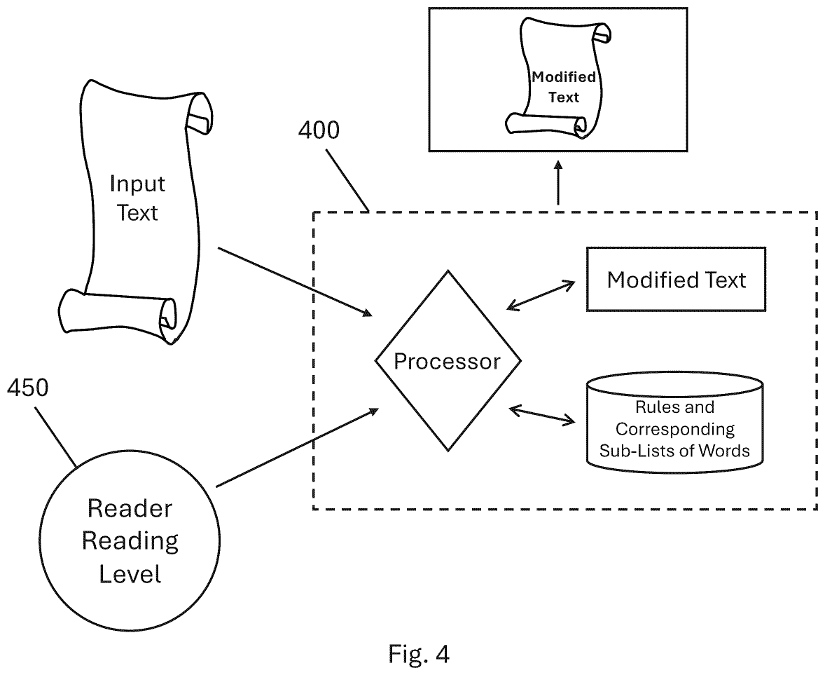

FIG. 4 illustrates another computer system in accordance with one or more implementations of the present disclosure. As shown in FIG. 4, the computer system 400 may receive a reader reading level 450 as an input to the computer system 400. In some implementations, the computer system 400 may receive manual input in order to determine a reading level of the reader. Such an implementation may beneficially provide a customizable and interchangeable experience between readers.

The computer systems 200, 300, and 400 may each include or access a filter. As previously suggested, the filter (e.g., 120, 152, 201) may have various embodiments or structures. In some examples, the filter may actively process the input by determining the words in the input, accessing a database to identify the rules associated with the words and determine whether the words are known words or unknown words.

In another example, the filter may be a list of words associated with a reading level (and/or set of one or more rules). Any word in the input found in this list may be visually distinguished. In this example, the database may associate reading levels with a list of words such that the list can be retrieved from a database based on reading level.

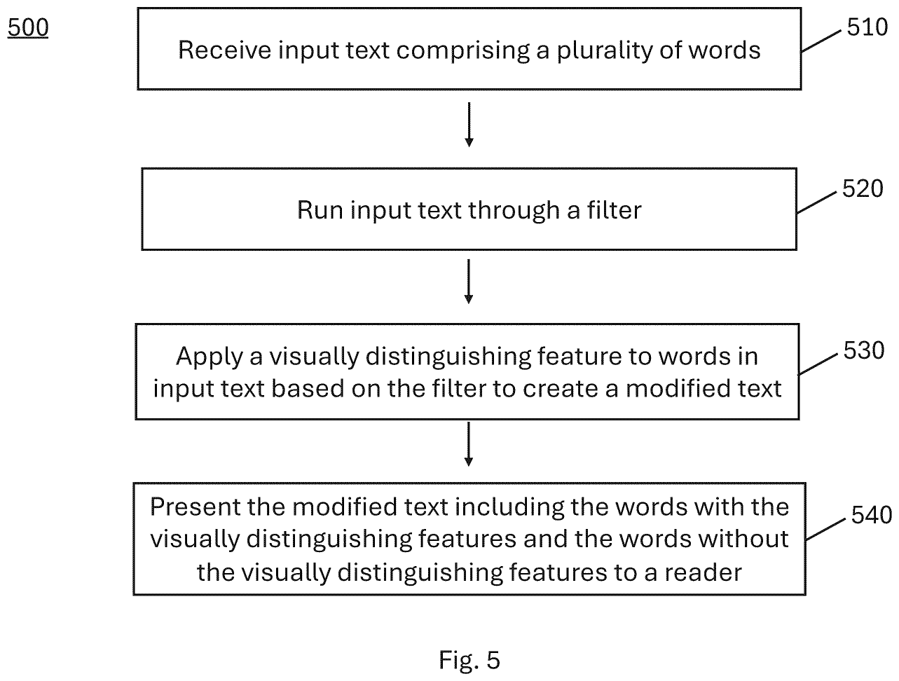

FIG. 5 illustrates a flowchart of a method in accordance with one or more implementations of the present disclosure. As shown in FIG. 5, the method 500 may include an act 510 that may include receiving input text comprising a plurality of words. The method 500 may also include an act 520 that may include running the input text through a filter. The method 500 may additionally include an act 530 that may include applying a visually distinguishing feature to words in the input text based on the filter to create a modified text. The method 500 may also include an act 540 that includes presenting the modified text including the words with the visually distinguishing feature and the words without the visually distinguishing features to a reader.

Embodiments of the invention allow the output to be adapted on the fly. For example, portions that have been read may be changed to that the user can keep their place in the text. Encouragement may be given when the reader successfully reads a word being learned, or the like. Statistics may be generated for the benefit of the reader/curriculum/teacher. This may allow the effectiveness of the curriculum to be evaluated, lead to changes in the curriculum (e.g., create a lesson for rules that seem particularly difficult for certain reading levels), and the like.

Embodiments of the invention may also relate to small group instruction. Embodiments of the invention allow students of varying reading levels to participate and learn collaboratively. For example, the reading system may allow a teacher (or other user such as tutor or parent) to assign some number of distinct lessons that are tailored to each student's reading proficiency. The known words are highlighted according to the relevant reading levels of the students. For instance, assuming that 18 lessons are assigned or available (embodiments are not limited to any particular number), words covered in lessons 1-6 are bolded in a first color (e.g., black), words from lessons 7-12 are bolded in a second color (e.g., red), and words from lessons 13-18 are bolded in a third color (e.g., blue). In another example, known words are bolded (or given a distinct visual appearance) by lesson rather than lesson groupings to further accommodate varying reading levels in a group environment.

Color coding according to level, lesson, groupings of lessons, or the like ensures that each student can clearly identify the words they are expected to read based on their assigned level. In a small group setting, students can read together, fostering a collaborative learning environment and advantageously maintaining individualized instruction. Embodiments of the invention allow each student's progress to be tracked at least because the color-coded (or other visual effect) text makes it easier to identify the words a student has mastered and which require further practice. By blending individualized learning with group dynamics, embodiments of the invention enhance reading practice and help teachers or other educators provided targeted support, even in group settings.

The present invention may comprise or utilize a special-purpose or general-purpose computer system that includes computer hardware, such as, for example, one or more processing modules and system memory, as discussed in greater detail below. The scope of the present invention also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processing modules, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processing modules, hand-held devices, multi-processing module systems, microprocessing module-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Any implementation or elements of implementations described herein may be combined with, replaced by, and/or added to any other implementation and/or elements of implementations described herein.

Following are some further example implementations of the invention. These are presented only by way of example and are not intended to limit the scope of the disclosure at all.

Implementation 1. A method for facilitating development of reading comprehension, comprising: receiving input text comprising a plurality of words; running the input text through a filter; applying a visually distinguishing feature to words in the input text based on the filter to create a modified text; and presenting the modified text including the words with the visually distinguishing feature and the words without the visually distinguishing feature to a reader.

Implementation 2. The method according to implementation 1, wherein the method further comprises determining a reading level of the reader.

Implementation 3. The method according to implementation 2, wherein the method further comprises creating a list of known words based on the reading level of the reader.

Implementation 4. The method according to implementation 3, wherein the list of known words is used to create the filter and the visually distinguishing feature is applied to words in the input text that correspond to words in the list of known words.

Implementation 5. The method according to implementation 2, wherein determining the reading level of the reader comprises identifying one or more rules that the reader has learned.

Implementation 6. The method according to implementation 2, wherein determining the reading level of the reader comprises automatically determining the reading level of the reader based on one or more prior reading sessions with the reader.

Implementation 7. The method according to implementation 2, wherein determining the reading level of the reader comprises receiving manual input that indicates the reading level of the reader.

Implementation 8. The method according to implementation 1, wherein the visually distinguishing feature comprises a bold typeface, an italicized typeface, a highlight, a different color typeface, an underlined typeface, or a different sized typeface than words without the visually distinguishing feature.

Implementation 9. The method according to implementation 1, wherein the input text comprises a book, an article, an eBook, a PDF file, a Microsoft Word® document, a webpage, an email message, a blog post, a social media post, a text message, an online forum, a newsletter, a brochure, a magazine, a journal, a report, or any other digital or physical text.

Implementation 10. A computer system that facilitates development of reading comprehension, said computer system comprising: one or more processors; and one or more computer-readable hardware storage devices that store instructions that are executable by the one or more processors to cause the computer system to: receive input text comprising a plurality of words; run the input text through a filter, apply a visually distinguishing feature to words in the input text based on the filter to create a modified text; and present, on a graphical user interface, the modified text including the words with the visually distinguishing feature and the words without the visually distinguishing feature to a reader.

Implementation 11. The computer system according to implementation 10, wherein the one or more computer-readable hardware storage devices further store instructions that are executable by the one or more processors to cause the computer system to determine a reading level of a reader.

Implementation 12. The computer system according to implementation 11, wherein the one or more computer-readable hardware storage devices further store instructions that are executable by the one or more processors to cause the computer system to create a list of known words based on the reading level of the reader.

Implementation 13. The computer system according to implementation 12, wherein the one or more computer-readable hardware storage devices further store instructions that are executable by the one or more processors to cause the computer system to use the list of known words to create the filter and to apply the visually distinguishing feature to words in the input text that correspond to words in the list of known words.

Implementation 14. The computer system according to implementation 11, wherein determining a reading level of a reader comprises determining one or more rules that the reader has learned.

Implementation 15. The computer system according to implementation 11, wherein determining a reading level of a reader comprises automatically determining the reading level of the reader based on one or more prior reading sessions with the reader.

Implementation 16. The computer system according to implementation 11, wherein determining a reading level of a reader comprises receiving manual input that indicates the reading level of the reader.

Implementation 17. The computer system according to implementation 10, wherein the visually distinguishing feature comprises a bold typeface, an italicized typeface, a highlight, an underlined typeface, a different color typeface, or a different sized typeface than words without the visually distinguishing feature.

Implementation 18. The computer system according to implementation 10, wherein the input text comprises a book, an article, an eBook, a PDF file, a Microsoft Word® Document, a webpage, an email message, a blog post, a social media post, a text message, an online forum, a newsletter, a brochure, a magazine, a journal, or a report.

Implementation 19. A computer system that facilitates development of reading comprehension, said computer system comprising: one or more processors; and one or more computer-readable hardware storage devices that store instructions that are executable by the one or more processors to cause the computer system to: receive input text comprising a plurality of words; run the input text through a filter; apply a visually distinguishing feature to words in the input text based on the filter to create a modified text; present, on a graphical user interface, the modified text including the words with the visually distinguishing feature and the words without the visually distinguishing feature to a reader; and highlight, on the graphical user interface, each word in the modified text in succession as the reader reads the modified text.

Implementation 20. The computer system according to implementation 19, wherein each word is highlighted at a variable speed determined by the reader.

1. A method for facilitating learning to read, the method comprising:
receiving input comprising a plurality of words at a reading engine;
running the input through a filter to identify known words for the user in the input, wherein the filter is configured based on user inputs associated with a user;
applying a visually distinguishing feature to the known words in the input based on the filter to create an output; and
presenting the output including at least the known words with the visually distinguishing feature.

2. The method according to claim 1, further comprising determining a reading level of the user, wherein the known words include words known to the user and/or being learned by the user and wherein the user inputs include one or more of a reading level, a curriculum, an age, rules of a language, generally accepted rules of learning to read, based on a science of reading, based on a modern understanding of teaching a person how to read, and/or a diagnosis.

3. The method according to claim 2, further comprising determining a list of known words by the filter based on the reading level of the user.

4. The method according to claim 3, wherein the visually distinguishing feature is applied to the known words in the input that correspond to words in the list of known words identified by the filter.

5. The method according to claim 2, wherein determining the reading level of the user comprises identifying one or more rules that the user has learned, wherein the filter identifies words in the input that comply with the one or more rules the user has learned.

6. The method according to claim 2, wherein determining the reading level of the user comprises automatically determining the reading level of the user based on one or more prior reading sessions with the user and/or assessments of reading ability.

7. The method according to claim 2, wherein determining the reading level of the user comprises receiving manual input that indicates the reading level of the reader and/or wherein determining the reading level of the user comprises a physical and/or electronic assessment.

8. The method according to claim 1, wherein the visually distinguishing feature comprises a bold typeface, a different color typeface, an italicized typeface, highlighted text, an underlined typeface, or a different sized typeface than words without the visually distinguishing feature.

9. The method according to claim 1, wherein the input comprises a book, an article, an eBook, a PDF file, a Microsoft Word® document, a webpage, an email message, a blog post, a social media post, a text message, an online forum, a newsletter, a brochure, a magazine, a journal, a report, or any other digital or physical text.

10. The method according to claim 1, wherein the output comprises text, modified text, visually distinguished text, audio, and/or images.

11. The method according to claim 1, wherein each word in the output is highlighted at a variable speed determined by the reader.

12. The method according to claim 1, wherein the output comprises unknown words that are visually distinct from the known words.

13. The method according to claim 1, further comprising mapping a curriculum and/or curriculum of the user to a known curriculum in order to determine the reading level of the user.

14. The method according to claim 1, wherein: one or more of:
the reading engine includes a speech recognition engine to determine whether the user is reading the known words and/or the unknown words correctly; or
the reading engine reads the unknown words to the user.

15. The method according to claim 1, wherein the filter identifies the known words using a rule-based approach that identifies words that comply with rules known or being learned by the user or using a word database that associates words to reading level.

16. The method according to claim 1, wherein the output is configured to provide individualized instruction in a group setting.

17. The method of claim 16, further comprising applying multiple distinguishing features to the output, wherein each of the distinguishing features corresponds to a particular lessor or a group of lessons.
